(19) United States
(12) Patent Application Publication
(10) Pub. No.: US 2005/0062765 A1
(43) Pub. Date: Mar. 24, 2005

(54) Temporally dispersed modulation method

(75) Inventor: Edwin Lyle Hudson, Los Altos, CA (US)

Correspondence Address: Bo-In Lin, 13445 Mandoli Drive, Los Altos Hills, CA, 94022, US

(73) Assignee: eLCOS Microdisplay Technology, Inc.

(21) Appl. No.: 10/949,421

(22) Filed: Sep. 23, 2004

Related U.S. Application Data
(60) Provisional application No. 60/505,194, filed on Sep. 23, 2003.

(51) Int. Cl. G09G 5/10

(52) U.S. Cl. 345/692

(57) ABSTRACT

A display system includes a controller for carrying out a data bit modulation sequence for driving a display pixel. The controller applies a plurality of sets of data bits for representing a data word and temporarily dispersing the sets for sequentially writing to the display pixel whereby the display pixel displaying a temporarily dispersed intensity. The display system may be wide varieties of display systems including but not limited to a liquid crystal on silicon display, a digital micromirror display, a plasma panel display, or a direct view liquid crystal device.

This Application claims a Priority Date of Sep. 23, 2003, benefited from a previously filed Provisional Applications 60/505,194 filed on Sep. 23, 2003 by one of a common Applicant of this Patent Application.

### BACKGROUND OF THE INVENTION

1. Field of the Invention

The present invention pertains to image display systems. More particularly, this invention relates to an improved pulse width modulation technique in driving a pixel cell by temporarily dispersed modulation for reducing visual disruptions between adjacent pixels caused by transverse electrical fields applied to adjacent electrodes due to phase differences of weighted data bits asserted to adjacent pixels.

2. Description of the Prior Art

Recent developments of image display implemented with the pulse width modulation (PWM) techniques are confronted with a unique set of problems caused by the artifacts generated due to the application of PWM in addition to the common display elements. Particularly, the artifacts generated due to the dynamic false contouring (DFC) is an artifact that is most difficult to control. A DFC artifact is observed when an image has adjacent pixels that are close to the same gray level but which are presented temporally out of phase within the same data frame. These artifacts are originated from the features of human vision that estimate motion based on time thus perceiving the boundaries between these out of phase graphic elements as the dynamic contours.

For those of ordinary skill in the art, the control of the optical artifacts is an extremely important aspect of image generation. For example, flicker was deemed unacceptable during the introduction of television receivers in the 1940s when the original NTSC television system was deployed in the United States. For more details please refer to pages 60-62, “Television Standards and Practice” ed. Donald G Fink (published 1943). Therefore, there exists an urgent need to provide new and improved system configurations and methods to overcome such difficulties.

In order to better understand the background of the technical problems exist in the conventional display technologies, a general overview of the technological developments are first discussed. Over past few decades, various schemes exist to display information on displays. One familiar example of such device is a cathode ray tube commonly used in television receivers for the past 60 years. One newer approach to image generation is to use a constant intensity source to represent one picture element or sub-element. Examples of this approach include plasma display panels (PDPs) and the large area image generating billboards seen in major sporting arenas.

One particular aspect of image display involves the display of an image with properly adjusted gray scale shading to represent a brightness of each display element. In order to create gray scale shading when using such picture elements, a common practice is to use circuitry to turn on the constant luminance picture element for a calculated period of time that corresponds to the desired gray level. This practice relies on the eye tending to interpret a given intensity of a longer duration as being brighter than the same intensity when viewed for a shorter duration. By controlling the display time frames within a suitably short period, this technique can be quite effective to first order. One early example of such a display system may be found in U.S. Pat. No. 3,590,156, Easton, “Flat Panel Display System with Time Modulated Gray Scale.”

Other display devices have come into usage that utilize similar techniques to create gray scale. For example, in U.S. Pat. No. 4,566,935, Hornbeck discloses a spatial light modulator that using electrically controlled mirrors. The mirrors are hinged so that one electric charge tilts the mirror in a first given angle while a second electric charge tilts the mirror to a second given angle. By nature the mirrors only have the two positions. It is possible to devise a projection imaging system such that the illumination light is directed to a projection lens when the mirror is tilted to the “on” position and the illumination light is directed to a light dump when the mirror is tilted to the “off” position. Such a system can be made to display gray scale images provided techniques similar to those previously described are used to electrically modulate the position of the tilting mirrors. Projection devices using similar techniques are now sold commercially, the spatial light modulator having been developed and made available by Texas Instruments under its DLP trademark. These principles are well known to those experienced in the art.

Pulse width modulation techniques have also been applied to liquid crystal display devices. For example, ferroelectrics liquid crystal devices using Smectic C aligned liquid crystal materials normally functions as a two-state polarization modulator, the electric field polarity across the liquid crystal causing the device to select one state or the other. In U.S. Pat. No. 4,367,924 Clark and Lagerwall disclose the details of such use of a ferroelectric device. Because the device selects between two states a display system can easily be devised using commonly understood principles of physical optics to encode information into polarized light incident on the display, said information being revealed when the resultant beam of light is analyzed by a polarizing element. Again the intensity generated by the device is either “on” or “off”, necessitating the use of pulse width modulation techniques similar to those previously described to create gray scale.

Another class of liquid crystal devices that may be pulse width modulated is that of nematic liquid crystal devices. Here the situation differs in that the drive waveform is binary, switching between two voltages in each DC balance state, one corresponding to “on” and the other to “off”. The liquid crystal material, however, responds at a rate quite a bit slower than the modulation rate. Thus the drive voltage is pulse width modulated between two drive voltages with the effect that an RMS voltage waveform is created that the liquid crystal responds to over a period of time commensurate with its step and frequency response times. Devices of this type were disclosed early in the development of liquid crystal display device, the primary application being digital watches with some difference in transmission between day and night.

A similar technique for providing pulse width modulation to nematic liquid crystal devices in liquid crystal on silicon (LCOS) displays is disclosed in U.S. Pat. No. 6,444,356, among others. A method for modulating a liquid crystal device quite similar to the previously described pulse width modulation devices is described. As will be further discussed below, the conventional width modulation (PWM) techniques are still confronted with the problems of DFC when PMW is applied.

Specifically, when the display elements are modulated by applying the PWM methods, the DFC artifacts are observed when an image has adjacent pixels that are close to the same gray level but which are presented temporally out of phase within the same data frame. These artifacts are originated from the features of human vision that estimate motion based on time. One pronounced such artifact occurs when a region at 128/256 gray level is adjacent to a region at 127/256 gray level. In a classic binary weighted display after the type shown in FIG. 1, the two data sequences are completely out of phase with each other. Unlike some of the optical sensors, human vision is not sensing the optical signals on the basis of temporally subdivided data frames and continuously carries out a signal integration. Images with adjacent pixels having such phase discrepancies appear as normal display elements during a static period until the observer blinks or moves his or her eyes. The manifestation is of a false contour seen when moving that is not present in static data, unless the eyes generate the motion. The dynamic false contours are distracting to all observers and as a result have been the subject of significant research on the part of companies seeking to ship commercial products that use pulse width modulated images.

The dynamic false contour optical artifact has appeared to some extent in all pulse width modulated displays where the modulation scheme is reflected to some degree in the images from the display device. Scientists employed by the plasma display panel industry have presented many papers on the topic and many of those techniques are subsequently filed as patent applications and issued into patents. The same artifact has appeared in projection devices based on the digital micromirror device (DMD) from Texas Instruments and in experimental television systems manufactured using ferroelectric liquid crystal devices. One solution application to LOCOS displays is disclosed in U.S. Pat. Nos. 6,151,011 and 6,326,380, the contents of these patents are hereby incorporated by reference. The patents disclose a method of preparing data for display on an LCOS device is that takes data for higher order binary-weighted data bits, restating them into a larger number of equally weighted bits, and then displaying them in time contiguous fashion so the number of points of lateral field between adjacent pixels is reduced significantly. While effective in itself the scheme selected still is prone to additional artifacts

In one implementation the lower order binary-weighted bits are placed adjacent to the first equally weighted bit. While sufficient for static images this scheme still displays motion artifacts that are objectionable to observers. In a second scheme the lower order binary-weighted bits are placed adjacent to the highest equally weighted bit. Here even static images are objectionable because human vision perceives the binary weighted bits as being part of the adjacent set of data. This creates, for example, in gray scale ramps, where each column in a set is incremented by one gray level over its neighbor in a monotonic fashion, a perceived major discrepancy where instead of increasing intensity, periodic anomalies of lower intensity are perceived. The scheme also retains all motion artifacts.

One factor unique to pulse width modulated nematic displays is a problem with lateral field effects. These occur when adjacent pixels have a strong potential difference for an extended period of time. They are most objectionable when the resultant rotation of the liquid crystal material between the adjacent pixels results in a significant intensity difference in the interpixel area. At mid level binary-weighted gray scales in a transition from 127/256 to 128/256, for example, the data between two pixels is out of phase 100%. of the time. The result would be a bright line placed between two pixels of almost identical gray scale.

Such problems exist due to the facts that the display elements are perceived by human eyes in a different way than regular optical sensors and these differences are not well considered even though the subjects of human perception of electronic images is a well-studied area. Because of differences between how natural objects exist and the light reflected from those objects is perceived, system developers are always confronted with the task of deceiving the human vision system into perceiving a thing when presented with stimuli quite different from that found when viewing the actual thing in nature. Even at its best humans perceive an electronic image as a representation of an item and not as the item itself. As a consequence the field of image replication for human viewing is replete with examples where peculiarities of vision result in innovations to satisfy the vision system that it is seeing a valid image.

For these reasons, there is still need in the art of electronic image display technologies to provide improved system configuration and methods to eliminate the disrupted visual effects generated between two adjacent display elements, e.g., two adjacent in order to overcome the above-mentioned limitations and difficulties.

### SUMMARY OF THE PRESENT INVENTION

It is therefore an object of the present invention is to provide a novel system and method for reducing the visual disruption created by possible phase difference between data asserted on adjacent pixel electrodes such that the aforementioned technical difficulties and limitations can be resolved.

In one embodiment of the invention, in addition to employing compound data words that includes several groups of bits for asserting to a display pixel that are each asserted on a display pixel for a coequal time period depending on the data bits significant in an ascending order, this invention applies a dispersed sequence to reduce the disrupt visual effects among adjacent pixels.

In an alternate embodiment, the sequence of the equally weighted bits as disclosed in the present invention are dispersed to create at least two temporal “on” centers as gray scale increases and a higher number of equally weighted bits are required. Additionally, the cluster of lesser binary-weighted bits is now moved to a position near the temporal center of the sequence. The relocation of the lesser binary-weighted bits to the center guarantees the regular appearance of temporal phase differences that may influence a more smooth appearance when a sequence of gray scale shadings is perceived.

In summary, this invention discloses a method for displaying an image data on a pixel display element. The method includes a step of configuring a voltage control means within the display element for multiplexing and selecting an electrode voltage for applying to an electrode of the pixel display element. The method further includes a step of providing a voltage controller

These and other objects and advantages of the present invention will no doubt become obvious to those of ordinary skill in the art after having read the following detailed description of the preferred embodiment, which is illustrated in the various drawing figures.

### BRIEF DESCRIPTION OF THE DRAWINGS

FIG. 1 is a frame of equally weighted data bits applying to a pixel circuit according to a ascending order based on a prior art patented disclosure.

FIG. 2A is a frame of dispersed sequence for applying the equally weighted bit to a pixel circuit of this invention.

FIG. 2B is a diagram for showing a primary binary weighted bit sequence and a number of alternate sequences for applying the equally weighted bit to a pixel circuit of this invention FIG. 3 is an alternate frame of dispersed sequence for applying the equally weighted bit to a pixel circuit of this invention.

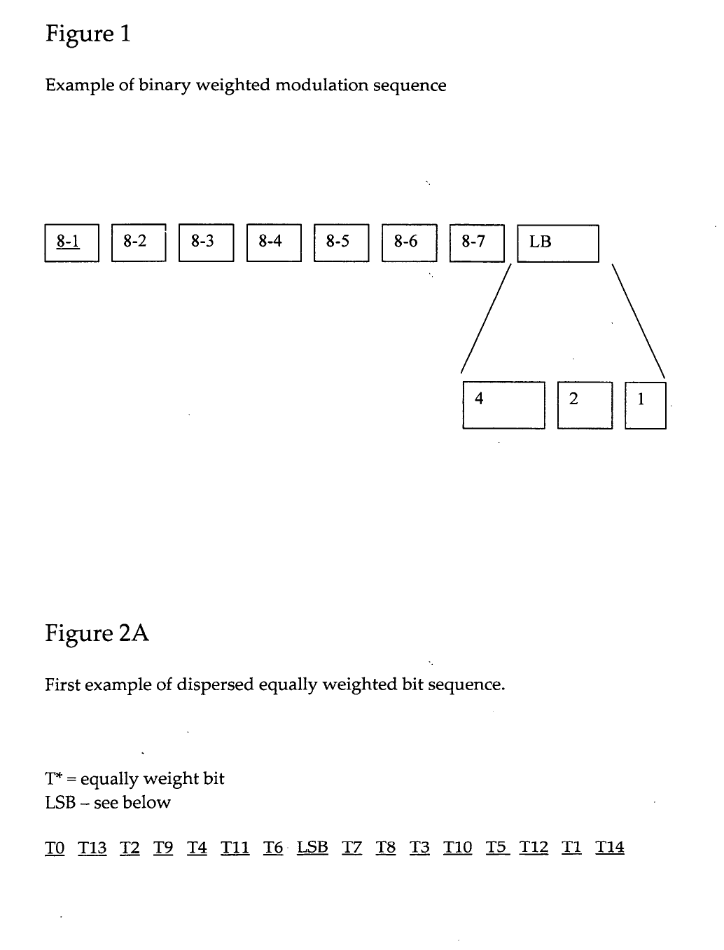

### DETAILED DESCRIPTION OF THE PREFERRED EMBODIMENT

The present invention addresses the foregoing problems in a unique and novel fashion. Special considerations are paid to the visual disruptions between adjacent pixels in order to reduce the number of temporal artifacts observed by modifying the order in which equally weighted data bits are shown. Unlike the methods used by the U.S. Pat. Nos. 6,151,011 and 6,326,380 wherein the binary weighted data words are converted into equally weighted words and asserting to the pixel circuit by ordering them in ascending or descending order. The sequence of the equally weighted bits as disclosed in the present invention are dispersed to create at least two temporal “on” centers as gray scale increases and a higher number of equally weighted bits are required.

Additionally the cluster of lesser binary-weighted bits is now moved to a position near the temporal center of the sequence. While it could remain at one end or the other, the relocation of the lesser binary-weighted bits to the center guarantees the regular appearance of temporal phase differences that may influence a more smooth appearance when a sequence of gray scale shadings is perceived.

Alternately, the position of the LSB sequence can be moved to another point within the overall sequence. It is placed in the middle because it is the most variable sequence and therefore its contribution to the distribution of intensity for a data frame is not predictable. That contribution rests solely on the source data. Other placements for within the scope of this invention.

It has been determined experimentally that with the present devices the motion contouring is least when the LSB segment is intact and the bits are not dispersed between the equally weighted bits. While adequate for static images other sequences are equally adequate. It can be foreseen that other liquid crystal or display types may find this approach acceptable, and these alternate sequences are also covered by the general scopes of this invention.

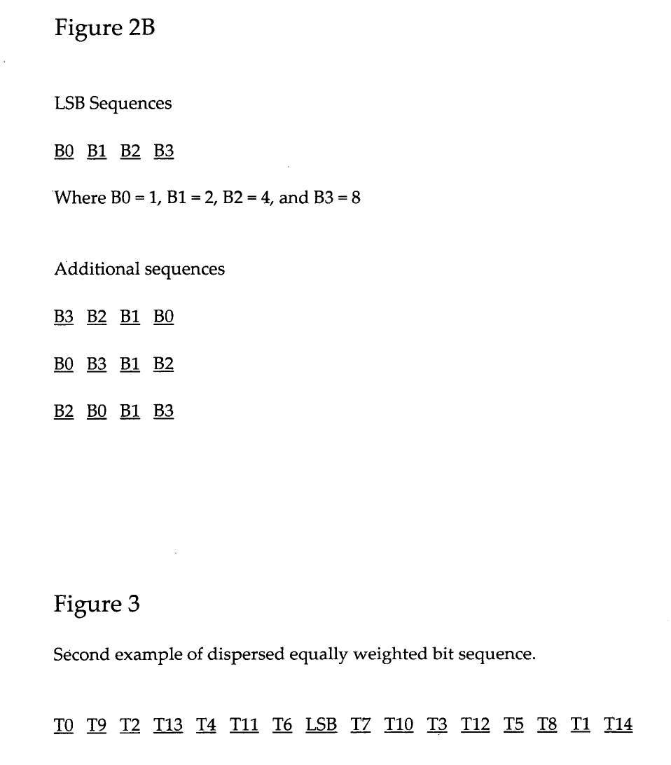

In a first sequence, depicted in FIG. 2A, a sequence is depicted that has been demonstrated experimentally to have only limited motion contouring artifacts and no static contouring effects whatsoever. By inspection it is easy to note that the sequence of equally weighted bits is now dispersed. In this example there are 15 equally weighted bits (t0 through t14) and four binary weighted bits (B0 through B3). This is equivalent to a binary weighted gray scale range of 256 bits or 2⁸. While 8 bit representations would be more efficient of bandwidth this sequence has fewer visual artifacts.

First, there is dispersion of the first eight (T0 through T7) of the 15 equally weighted bits wherein none of the equally weighted bits are adjacent to one another. Furthermore, the “even” equally weighted bits are positioned before the LSB segment while the “odd” equally weighted bits are placed after it, and the remaining seven equally weighted bits (T8 through T14) are similar dispersed with the “even” group located after the LSB segment and the “odd” group located before it. Thus the grouping insures that as additional equally weighted bits are added in response to a high gray scale generation requirement the dispersal continues.

The assignment of notations are based on the rules that the meaning of the sequence T0, T1, T2 etc is that T0 is the first logical data bit and must set to the “on state” before T1 or any remaining equally weighted bits can be set to “on”. In like manner T0 and T1 must both be on before T2 or any remaining equally weighted bits are set to on. This constraint continues throughout the remainder of the sequence. Thus the order number for an equally weighted bit denotes its place in the logical sequence of increasing gray scale.

FIG. 2B shows a primary binary weighted bit sequence and a number of alternatives. The display sequences do not result in obvious differences among each of these sequence arrays. However, such flexibilities are disclosed here for other implementation considerations including bandwidth or other reasons to select one over the other. All are considered to be within the scope of this invention.

FIG. 3 displays another sequence for the equally weighted bits. In this sequence none of the logically adjacent bits are placed temporally adjacent to a logical neighbor. This may offer some minor advantage but the difference in actual display are not obvious to visual inspections while more sensitive measurements may be employed to distinguish the quality of displays between each of these display sequences.

Further experiments have shown that placing a limited number of logically adjacent equally weighted bits in temporally adjacent slots has limited effect. We anticipate that there is an experimental dividing point that varies according to other criteria such as the brightness of the image, the fundamental data frame rate, the contrast of the image and the like. Such variances are within the scope of this invention.

According to above descriptions, this invention discloses a data bit modulation sequence for driving a display pixel wherein a plurality of sets of data bits representing a data word and the sets are temporarily dispersed for sequentially writing to the display pixel whereby the display pixel displaying an temporarily dispersed intensity. In a preferred embodiment, at least two of the sets of data bits are equally weighted sets. In another preferred embodiment, at least two of the sets of data bits are binary weighted sets. In another preferred embodiment, at least two of the sets of data bits are binary weighted sets and time contiguously written to the display pixel. In another preferred embodiment, at least two of the sets of data bits are binary weighted sets and time contiguously written to the display pixel near a middle portion of a sequence for writing the sets to the display pixel. In another preferred embodiment, at least two of the sets of data bits are equally weighted sets and dispersed in a first half and a second half of a sequence for writing the sets to the display pixel. In another preferred embodiment, at least two of the sets of data bits are equally weighted sets wherein the equally weighted sets are adjacent sets in the data word. In another preferred embodiment, at least two of the sets of data bits are equally weighted sets wherein the equally weighted sets are adjacent sets in the data word and time-contiguously written to the display pixel. In another preferred embodiment, at least two of the sets of data bits are equally weighted sets wherein none of the equally weighted sets are time-contiguously written to the display pixel. In another preferred embodiment, at least two pairs of the sets of data bits are equally weighted sets wherein the two pairs of equally weighted sets are adjacent sets in the data word and each of the pairs are time-contiguously written to the display pixel. In another preferred embodiment, at least two of the sets of data bits are equally weighted sets and at least two of the sets of data bits are binary weighted sets wherein the binary weighted sets are temporarily dispersed between the equally weighted sets.

This invention further discloses a display system having a controller for carrying out a data bit modulation sequence for driving a display pixel. The controller applies a plurality of sets of data bits for representing a data word and temporarily dispersing the sets for sequentially writing to the display pixel whereby the display pixel displaying an temporarily dispersed intensity. In a preferred embodiment, the display system is a liquid crystal on silicon display. In a preferred embodiment, the display system is a digital micromirror display. In a preferred embodiment, the display system is a plasma panel display. In a preferred embodiment, the display system is a direct view liquid crystal device.

Although the present invention has been described in terms of the presently preferred embodiment, it is to be understood that such disclosure is not to be interpreted as limiting. Various alternations and modifications will no doubt become apparent to those skilled in the art after reading the above disclosure. Accordingly, it is intended that the appended claims be interpreted as covering all alternations and modifications as fall within the true spirit and scope of the invention.

1. A data bit modulation sequence for driving a display pixel wherein:
a plurality of sets of data bits representing a data word wherein said sets are temporarily dispersed for sequentially writing to said display pixel whereby said display pixel displaying an temporarily dispersed intensity.

2. The data bit modulation sequence of claim 1 wherein:
at least two of said sets of data bits are equally weighted sets.

3. The data bit modulation sequence of claim 1 wherein:
at least two of said sets of data bits are binary weighted sets.

4. The data bit modulation sequence of claim 1 wherein:
at least two of said sets of data bits are binary weighted sets and time contiguously written to said display pixel.

5. The data bit modulation sequence of claim 1 wherein:
at least two of said sets of data bits are binary weighted sets and time contiguously written to said display pixel near a middle portion of a sequence for writing said sets to said display pixel.

6. The data bit modulation sequence of claim 1 wherein:
at least two of said sets of data bits are equally weighted sets and dispersed in a first half and a second half of a sequence for writing said sets to said display pixel.

7. The data bit modulation sequence of claim 1 wherein:
at least two of said sets of data bits are equally weighted sets wherein said equally weighted sets are adjacent sets in said data word.

8. The data bit modulation sequence of claim 1 wherein:
at least two of said sets of data bits are equally weighted sets wherein said equally weighted sets are adjacent sets in said data word and time-contiguously written to said display pixel.

9. The data bit modulation sequence of claim 1 wherein:
at least two of said sets of data bits are equally weighted sets wherein none of said equally weighted sets are time-contiguously written to said display pixel.

10. The data bit modulation sequence of claim 1 wherein:
at least two pairs of said sets of data bits are equally weighted sets wherein said two pairs of equally weighted sets are adjacent sets in said data word and each of said pairs are time-contiguously written to said display pixel.

11. The data bit modulation sequence of claim 1 wherein:
at least two of said sets of data bits are equally weighted sets and at least two of said sets of data bits are binary weighted sets wherein said binary weighted sets are temporarily dispersed between said equally weighted sets.

12. A display system having a controller for carrying out a data bit modulation sequence for driving a display pixel wherein:
said controller applying a plurality of sets of data bits for representing a data word and temporarily dispersing said sets for sequentially writing to said display pixel whereby said display pixel displaying an temporarily dispersed intensity.

13. The display system of claim 12 wherein:
at least two of said sets of data bits are equally weighted sets.

14. The display system of claim 12 wherein:
at least two of said sets of data bits are binary weighted sets.

15. The display system of claim 12 wherein:
at least two of said sets of data bits are binary weighted sets and time contiguously written to said display pixel.

16. The display system of claim 12 wherein:
at least two of said sets of data bits are binary weighted sets and time contiguously written to said display pixel near a middle portion of a sequence for writing said sets to said display pixel.

17. The display system of claim 12 wherein:
at least two of said sets of data bits are equally weighted sets and dispersed in a first half and a second half of a sequence for writing said sets to said display pixel.

18. The display system of claim 12 wherein:
at least two of said sets of data bits are equally weighted sets wherein said equally weighted sets are adjacent sets in said data word.

19. The display system of claim 12 wherein:
at least two of said sets of data bits are equally weighted sets wherein said equally weighted sets are adjacent sets in said data word and time-contiguously written to said display pixel.

20. The display system of claim 12 wherein:
at least two of said sets of data bits are equally weighted sets wherein none of said equally weighted sets are time-contiguously written to said display pixel.

21. The display system of claim 12 wherein:
at least two pairs of said sets of data bits are equally weighted sets wherein said two pairs of equally weighted sets are adjacent sets in said data word and each of said pairs are time-contiguously written to said display pixel.

22. The display system of claim 12 wherein:
at least two of said sets of data bits are equally weighted sets and at least two of said sets of data bits are binary weighted sets wherein said binary weighted sets are temporarily dispersed between said equally weighted sets.

23. The display system of claim 12 wherein:
said display system comprising a liquid crystal on silicon display.

24. The display system of claim 12 wherein:
said display system comprising a digital micromirror display.

25. The display system of claim 12 wherein:
said display system comprising a plasma panel display.

26. The display system of claim 12 wherein:
said display system comprising a direct view liquid crystal device.
